(19) United States
(12) Patent Application Publication
(10) Pub. No.: US 2025/0334210 A1
(43) Pub. Date: Oct. 30, 2025

(54) FASTENER WITH SPIRAL BROACHING RIBS

(71) Applicant: Penn Engineering & Manufacturing Corp., Danboro, PA (US)

(72) Inventor: David Coen, Galway (IE)

(21) Appl. No.: 18/644,721

(22) Filed: Apr. 24, 2024

(51) Int. Cl. F16L 5/00

(52) U.S. Cl. CPC F16L 5/00

(57) ABSTRACT

A fastener has an axial through bore and a flange located at a bottom portion of the fastener. The flange has an upward facing top contact surface. An axially extending collar on a top portion of the fastener extends upwardly from the contact surface of the flange. A plurality of ribs are positioned along the outer surface of the collar and extend axially downward to the flange contact surface where they translate to the lateral direction at a transition bend. Each of the ribs follows a straight axial path along the collar and then uninterruptedly transitions to a spiral path on the flange contact surface. All of the ribs are tapered both vertically and width-wise with the maximum height of each rib being greatest at the transition bend.

### FIELD OF THE INVENTION

The present invention relates to fasteners which attach themselves to workpieces by the deformation of the workpiece to which the fastener is forceable applied. More specifically it relates to a bushing used in an electrical circuit that broaches into a hole of a receiving member.

### BACKGROUND OF THE INVENTION

In the electrical arts a fastener often acts as a connection point enabling the transfer of current from one busbar to another. Typically, the material of the fastener is copper with a plated outer conductive layer to limit surface oxidation. In one means of attachment the fastener can be pressed into a busbar or similar substrate enabling a low-resistance current path through the connection surfaces. A special geometry on the fastener allows the fastener to penetrate any oxide layers on the surface of the substrate. The shape of the lugs extending along the shank and under the head surface of the fastener maximises the contact area and provides resistance to any unwanted applied torque.

In a bolted joint connection, the electrical resistance is a function of the resistivity by the length divided by the area. The addition of an oxide layer can significantly increase the electrical resistance of the joint. The oxide layer effectively has its own resistivity value. From testing carried out the oxide layer present on an aluminium busbar can result in over a 10-fold increase in electrical resistance. This compares with the electrical resistance of the same fasteners installed in freshly prepared aluminium.

One of the issues associated with installing a copper clinch fastener into a copper busbar is trying to achieve a suitable hardness differential between the two materials. Failure to achieve a suitable differential can result in the deformation of the fastener preventing material cold flow in the panel and resulting in the reduced mechanical performance of the joint. This is an issue as the higher conductive copper has a similar hardness to the busbar.

There is therefore a need in the electrical arts for a fastener which overcomes the difficulties with electrical connections described above. It is one of the objects of the invention to provide a fastener for electrical connections which solves the electrical resistance problems associated with oxide accumulation and lug contact area. There is a need for an electrically conductive fastener which will permit the use of materials of the same hardness.

### SUMMARY OF THE INVENTION

The present inventive fastener has been devised in order to meet the needs in the fastener arts described above and to achieve its above-stated objects. It has been found that gradually tapered lug ribs ns a curved pattern has proven to solve the problems in the prior art. The fastener of the invention can be installed in a panel without any deformation of the fastener, thus enabling a fully functional mechanical clinch joint.

Furthermore, the addition of the spiral rib features to the fastener breaks this oxide layer on the substrate permitting direct contact between the plated fastener surface and the substrate material. Testing carried out in an aged Aluminium busbar indicates a 10-fold decrease in electrical resistance over direct surface-to-surface contact. Since the function of the fastener is to carry current through the clinch joint the presence of an oxide layer may impede this. The invention also provides a larger contact area for greater electrical current capacity and for minimising heat generated in the joint.

More specifically, the invention is a fastener comprising a fastener with an axial through bore and flange located at a bottom portion of the fastener, said flange having an upward facing top contact surface. An axially extending collar on a top portion of the fastener extends upwardly from a contact surface of the flange. A plurality of ribs are positioned along the outer surface of the collar and extending axially downward to the flange contact surface where they translate to the lateral direction at a bend and then follow a curved path on the flange contact surface.

The ribs follow a curved bend as they transition uninterruptedly from the axial to the radial direction. The ribs spread out radially from the collar along the top contact surface of the flange. The ribs are curved in a lateral plane perpendicular to an axis of the fastener and describe a spiral pattern from an axial top view. Each of the ribs preferably follows a straight axial path along the collar. All of the ribs are tapered both vertically and width-wise with the maximum height of each rib being greatest at a transition bend where they uninterruptedly transition from axial to lateral orientation. In one particular embodiment, the fastener has twenty-four ribs equally spaced fifteen angular degrees apart. The fastener can be in the form of an internally threaded bushing as well as other types of hardware similarly constructed. One embodiment is an electrically conductive bushing.

Even greater specificity of the invention will be seen the following drawings which show and describe a preferred embodiment. Other modifications and adaptions will be apparent to those of skill in the art from the following description.

### BRIEF DESCRIPTION OF THE DRAWINGS

FIG. 1 is top right isometric view of one embodiment of the invention.

FIG. 2 is a closeup partial elevation sectional view of one of the ribs.

FIG. 3 is a top view thereof.

FIG. 4 is partially sectioned elevation view thereof.

FIG. 5 is a top plan view of FIG. 4.

### DESCRIPTION OF THE PREFERRED EMBODIMENT

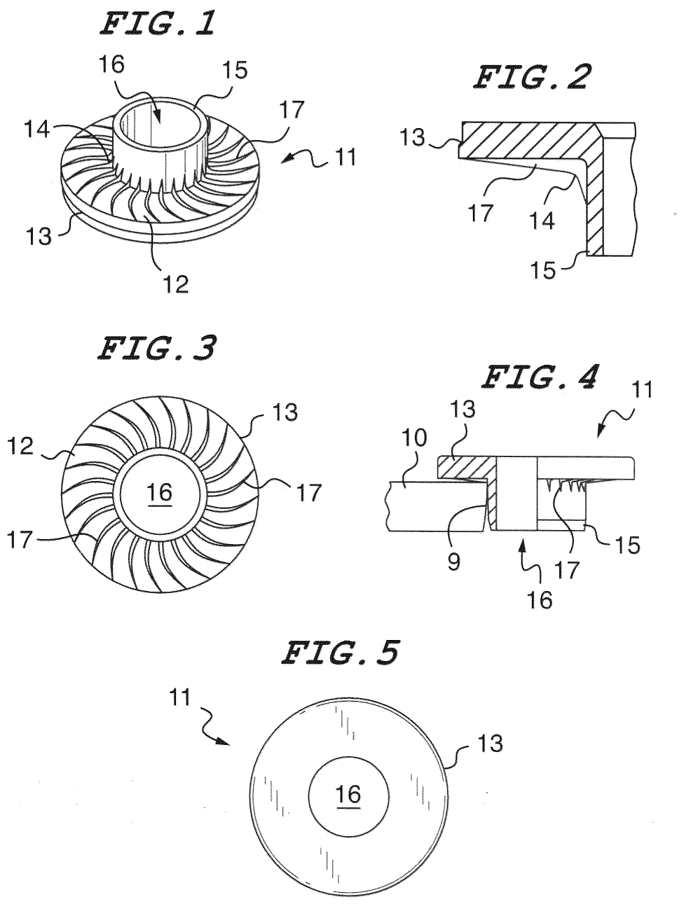

Referring now to FIG. 1, a top view of one embodiment of the invention is shown. In this embodiment a bushing 11 is depicted which has a flange 13 at the bottom and an axial collar 15 that extends upwardly from the flange contact surface 12. The bushing has an axial through bore 16 which may be internally threaded. A series of protruding ribs 17 lie along the axial collar 15 extending along a straight line downward to the lateral contact surface 12 of the flange 13 where they spread out radially along a curved path. The ribs 17 each follows an axial straight path downward along the collar 15 but then follow a spiral path as they travel along the top contact surface of the flange 13. Alternatively, the rib path on the flange may not be exactly spiral but be circular, having a constant radius.

The ribs are each tapered in both width and verticality toward their distal ends where they meet the surface of the fastener. The height of each rib is the greatest at the junction of the collar and flange where the ribs follow a curved bend 14 as they transition uninterruptedly from the axial to the radial direction. This transition portion 14 of the ribs is important to its successful operation of the bushing. The curved path of the ribs on the contact surface of the flange provides greater rib density for the same number of ribs.

FIGS. 2 through 5 show various views of the features of one embodiment of the invention seen and as described in FIG. 1 above. Like numbering of the same features has been employed throughout the different figures.

Referring now to FIG. 2, an enlargement of the transition portion of one rib 17 for sake of illustration. The transition portion of the continuous ribs along the inner corner at the collar 15 and flange 13 junction is clearly seen in this figure. The axially curved bend 14 is occupied by the greatest height of the ribs. This permits the ribs to penetrate strongly into the edge of the receiving hole of the substrate where the pressure exerted on the parts can be the greatest. Thus, the opportunity for total penetration of oxidated layers on the surface of the substrate is enhanced.

Referring now to FIG. 3, here we see from a top end view the spiral pattern of the ribs as they travel along the lateral top surface of the flange from their transition portion at the base of the collar. The ribs taper in both height and length, converging with the surface of the fastener at their distal ends. In this embodiment they terminate short of the outer circumference of the flange and the end of the collar. In both cases the distal ends of the ribs terminate at the contact surface of the flange. This embodiment of the invention has twenty-four ribs 17 spaced fifteen angular degrees apart.

FIG. 4 is a sectioned elevation view and perspective top view are shown. In FIG. 4 we see the flange 13 of bushing 11 mating with panel 10 received in hole 9. The size, dimensions and arrangement of the ribs allows its successful use with materials of the panel and bushing having like hardness.

FIG. 5 is a top view of FIG. 4. The surface 8 of the flange 13 is on the side of the flange opposite the collar is ring shaped. The through bore 16 is clearly illustrated in this figure which can be internally threaded although threads are not shown.

When used, the bushing is forceably applied by pressing the collar 15 into a hole 9 of a receiving panel 10 seen in FIG. 4. The ribs broach into the mating surfaces of the panel thereby making a reliable connection between the bushing and the panel while resisting rotation. The straight ribs in the axial direction along the collar broach into the material of the panel hole allowing for contact on the inner hole surface of the panel. The ribs are also tapered to a point so that the problems of hardness differential and oxide layer penetration are overcome while maximising the surface-to-surface contact between the bushing and the panel. The tapered ribs thus provide the necessary strength to broach into similar hardness materials. The shape of the ribs ensures the oxide layer is broken providing reliable electrical contact. The spiral pattern increases the contact surface area compared to a straight rib extending radially, thus increasing the ampacity of the joint.

The embodiment shown in the figures of drawing is a bushing but the unique spiral rib configuration could be applied to other types of fasteners. The foregoing is considered as illustrative only of the principles of the invention. Further modifications will be apparent to those of skill in the fastener and electrical arts. It is not intended that the invention be limited by the embodiments described herein but be limited only by the following claims and their legal equivalents.

What is claimed is:

1. A fastener, comprising:
a fastener with an axial through bore and flange located at a bottom of the fastener,
a flange having an upward facing and laterally disposed top contact surface;
an axially extending collar on a top portion of the fastener extending upwardly from the flange contact surface; and
a plurality of ribs positioned along the outer surface of the collar and extending axially downward to the flange contact surface where they translate uninterrupted to the lateral direction after a bend and then following a curved path on the contact surface of the flange.

2. The fastener of claim 1 wherein the ribs each follows a straight axial path along the collar.

3. The fastener of claim 1 wherein each of the ribs are tapered both vertically and width-wise, the maximum height of each rib being greatest at the bend in a transition portion of the rib.

4. The fastener of claim 1 having twenty-four ribs equally spaced fifteen angular degrees apart.

5. The fastener of claim 1 having an axial through bore.

6. The fastener of claim 5 wherein the through bore is internally threaded.

7. The fastener of claim 1 wherein the fastener is electrically conductive.

8. The fastener of claim 1 wherein the curved path is circular.

9. The fastener of claim 1 wherein the curved path is a spiral.

10. The fastener of claim 3 wherein the distal ends of the ribs terminate at the contact surface of the flange.

11. An assembly of the fastener of claim 1 affixed to a panel wherein the fastener is broached into a hole of the panel by pressing, and wherein the hardness of the fastener and the panel are of like hardness.
